(19) United States
(12) Patent Application Publication
(10) Pub. No.: US 2024/0115893 A1
(43) Pub. Date: Apr. 11, 2024

(54) FIRE EXTINGUISHING DEVICE

(71) Applicants: Tobias RUHE, Stuttgart (DE); Henning ELSÄßER, Herrenberg (DE)

(72) Inventors: Tobias RUHE, Stuttgart (DE); Henning ELSÄßER, Herrenberg (DE)

(21) Appl. No.: 18/483,613

(22) Filed: Oct. 10, 2023

(30) Foreign Application Priority Data
Oct. 11, 2022 (DE) 10 2022 126 424.6

(51) Int. Cl. A62C 37/10; A62C 99/00

(52) U.S. Cl. CPC A62C 37/10; A62C 99/0072

(57) ABSTRACT

A fire extinguishing device for automatically fighting fires, having a housing, which includes at least one fastening means for fastening the device on a wall or ceiling, in particular of a building, having an extinguishing agent container, arranged in the housing, having a fluid extinguishing agent in particular, having at least one spray nozzle for discharging the extinguishing agent from the extinguishing agent container, having at least one sensor designed to detect a fire and its position in the surroundings of the device, and having at least one control device designed to discharge the extinguishing agent from the extinguishing agent container through the at least one spray nozzle in the direction of the detected fire.

### CROSS-REFERENCE TO RELATED APPLICATIONS

This application claims the benefit of priority to German Application No. 10 2022 126 424.6, filed Oct. 11, 2022, the entire disclosure of which is hereby incorporated herein by reference.

### FIELD OF THE INVENTION

The invention relates to a fire extinguishing device for automatically fighting a fire.

### BACKGROUND OF THE INVENTION

Fire extinguishing devices that fight a fire automatically are basically already known from the prior art. Through automated extinguishing processes, fires can already be fought at an early stage, even before the fire department arrives, for example. So-called sprinkler systems are widely used, which include multiple sprinklers distributed in a room or building, usually attached to a ceiling, which are connected to an extinguishing agent source by a common pipe system. The extinguishing agent source is, for example, a main water connection of the building or a separate extinguishing agent tank, to which a pump is assigned, by means of which the extinguishing agent can be supplied from the extinguishing agent tank to the sprinklers through the pipe system. The pipe system is often under pressure and the extinguishing agent is prevented from escaping undesirably through the sprinklers by means of closed valves. In the event of a fire, such sprinklers are triggered, for example, depending on the temperature prevailing in the immediate surroundings of the respective sprinkler. For this purpose, for example, bi-metal strips or other temperature-sensitive elements are used, which react when the temperature is exceeded without the supply of electrical energy and open the valve.

A disadvantage of known sprinkler systems is that they cannot fight a fire in a targeted manner, but are only limited to a room or the possible area of effect of the sprinkler. This can result in the actual fire or source of the fire not being directly affected by the extinguishing agent, but objects located in the room or in the area of effect of the sprinkler being by with the extinguishing agent and thereby damaged. This results in additional damage.

In addition, such sprinkler systems require a complex pipe system having high-performance pumps and/or pressure generators, wherein the entire sprinkler system usually already has to be taken into consideration during the production and construction and design of a building. Particularly for private individuals in private households, the costs of such a sprinkler system usually result in other means being used, such as local fire extinguishers operable by a user. However, such fire extinguishers are only effective when the user grabs them and uses them. By this time the fire may have already spread and caused further damage. In the worst case scenario, no one is present who could operate the fire extinguisher.

### BRIEF SUMMARY OF THE INVENTION

The present invention is therefore based on the object of creating an improved fire extinguishing device which enables automated fire fighting without requiring complex and cost-intensive installation.

The object on which the invention is based is achieved by a fire extinguishing device having the features of claim 1. The fire extinguishing device according to the invention has the advantage that it can be easily installed and used by anyone. The individual components of the fire extinguishing device are cost-effective and can also be combined inexpensively, so that private households can also easily install such a fire extinguishing device in their home. In addition, the fire extinguishing device according to the invention has the advantage that a source of fire is fought in a targeted manner, so that damage to other objects or items in the effective area of the fire extinguishing device is avoided. In particular, the fire extinguishing device enables autonomous operation, which in particular does not require any electrical and/or hydraulic connections to the building in which the fire extinguishing device is to be used. This makes the handling of the fire extinguishing device particularly flexible, as it can be used by the user anywhere.

The fire extinguishing device according to the invention is characterized in that it includes a housing which includes at least one fastening means for fastening the device to a wall or ceiling, in particular a building, that an extinguishing agent container having a fluid extinguishing agent in particular is arranged in the housing, that at least one spray nozzle for discharging the extinguishing agent from the extinguishing agent container is arranged in or on the housing, that at least one sensor is arranged in or on the housing, which is designed to detect a fire and its position in the surroundings of the device, and that a control device is provided, which is designed to discharge the extinguishing agent from the extinguishing agent container through spray nozzles in the direction of the detected fire. The fire extinguishing device is also arranged in the housing. As a result, all components that are required to fight fire are arranged in and/or on the housing of the fire extinguishing device. The extinguishing agent is stored in the fire extinguishing device itself. It is not only detectable by the at least one sensor whether a fire exists in the immediate surroundings of the fire extinguishing device, but also in which direction the fire lies in relation to the fire extinguishing device. The control device can be used to expel the extinguishing agent in the direction of the fire in order to fight the fire directly and protect other areas in the room. In particular, the control device reacts automatically to output signals from the sensor in order to expel the extinguishing agent, so that a fully automated extinguishing process takes place when the fire is detected. Because the fire extinguishing device is designed as at least an extinguishing agent-autonomous device by providing the extinguishing agent, the user can arrange it anywhere in a desired room or on the ceiling, on the wall, if necessary also on the base or in a cabinet or a shelf. The at least one sensor and the at least one spray nozzle and the control device ensure that a fire can be combated accurately. According to a preferred embodiment of the invention, a plurality of spray nozzles are arranged on the housing and are oriented in different directions. In particular, the spray nozzles are arranged fixed on the housing, i.e., immovably. Because they are oriented in different directions, it is possible to apply the extinguishing agent in a desired direction, which corresponds to the orientation of the spray nozzle, by selecting a specific one of the spray nozzles. So, to fight the fire in a specific direction, the extinguishing agent is discharged through the spray nozzle that is most clearly oriented in the direction of the fire. For this purpose, the control device preferably includes a control unit which, depending on the data from the at least one sensor, actuates the spray nozzles and/or supplies them with the extinguishing agent from the extinguishing agent tank. According to an alternative embodiment of the invention, a sensor is connected to each spray nozzle, wherein the respective assigned sensor is oriented in the same direction as the spray nozzle. If a fire is detected by one of these sensors, this sensor automatically triggers the spray nozzle assigned thereto so that the extinguishing agent is automatically discharged in the direction of the fire.

Particularly preferably, each spray nozzle is assigned an activatable valve of the control device, by which the respective spray nozzle is connectable to the extinguishing agent container and disconnectable therefrom. Thus, by actuating the respective valve, the respective spray nozzle is activatable or deactivatable in order to be able to discharge the extinguishing agent in the desired direction.

Particularly preferably, the housing is trough-shaped and includes a base and a side wall protruding from the base and leading around the circumference of the base, wherein the sensors and the spray nozzles are preferably arranged in and/or on the base. Due to the trough shape, the essential elements of the fire extinguishing device are arrangeable in the housing and are advantageously protected from external influences. By arranging the sensors and spray nozzles in or on the base, the advantage is achieved that they are in an advantageous position for detecting and fighting a fire. According to an alternative embodiment, the sensors and/or the spray nozzles are arranged in and/or on the side wall of the housing.

Furthermore, it is preferably provided that the spray nozzles are arranged in a ring shape, in particular a circular ring shape, and in particular are each inclined to the base and oriented radially, so that they each point away from one another and can thus apply the extinguishing agent to different areas in the surroundings of the fire extinguishing device. The annular arrangement results in an advantageous coverage of the surroundings of the fire extinguishing device. In particular, the spray nozzles are arranged evenly distributed over the circumference of the housing. Due to the inclined orientation, the spray nozzles or the spray directions of the spray nozzles are inclined at an angle of less than 90° and greater than 0° to the base, in particular inclined at an angle between 5° and 40°, preferably at an angle of 15° the base. An inclined orientation does not mean that a cylindrical body of the spray nozzles has to be oriented so it is oriented externally recognizable from the outside. The inclined orientation refers to the spray cone or the spray direction, which is oriented inclined to the base. This can also be made possible by a lateral opening in a cylindrical body of the spray nozzle.

Preferably, at least one further spray nozzle is present, which is arranged centrally—in relation to the annular arrangement of the remaining spray nozzles and/or in relation to the base—and is oriented perpendicular to the base. This means that the extinguishing agent can also be applied to an area directly below the fire extinguishing device.

Furthermore, it is preferably provided that the at least one spray nozzle is held displaceably on the housing in order to be able to be oriented in different directions. In this case, the spray nozzle is not fixedly arranged on the housing, but rather in such a way that it can be oriented during operation in order to be able to accurately detect a fire or apply the extinguishing agent. This ensures that the fire extinguishing device requires fewer spray nozzles and in particular can be equipped with only a single spray nozzle. By orienting the spray nozzle depending on a detected fire, this fire is accurately subjected to the extinguishing agent and fought. Although an actuator system is necessary for the orientation of the displaceable spray nozzle, which enables accurate orientation, saving the remaining spray nozzles means that on the one hand installation space and on the other hand budget are available for the actuator system. The fire extinguishing device therefore preferably includes either a plurality of non-displaceable spray nozzles or only one, but displaceable spray nozzle. According to a further embodiment of the invention, the fire extinguishing device includes both a plurality of non-displaceable spray nozzles and at least one displaceable spray nozzle.

According to a preferred refinement of the invention, the at least one displaceable spray nozzle is assigned at least one electrically actuatable manipulator, which is designed to orient the spray nozzle in the direction in which a fire was detected. The spray nozzle can therefore be moved as needed in different directions by the electrically actuatable manipulator. It is expediently moved by the control device in the direction in which a fire was detected. Preferably, the manipulator is an electromechanical or electromagnetic manipulator or actuator that can displace the spray nozzle in at least one degree of freedom. For example, a first manipulator is provided which can pivot the nozzle around a vertical axis, preferably by at least 360 degrees, and a second manipulator which can pivot the nozzle around a horizontal axis, preferably by at least 90 degrees. For example, the spray nozzle is designed in the manner of a pivotable arm or robot arm.

According to a preferred refinement of the invention, the at least one sensor is designed as a thermopile sensor, infrared sensor, and/or camera sensor. The sensor is therefore suitable for detecting a fire based on its temperature and/or its visual appearance. If there is only a single sensor, it is preferably designed as a camera sensor, in particular as an infrared camera sensor, in order to be able to determine the direction in which the fire is located. The control device is preferably designed to use image evaluation to evaluate the image recorded by the camera sensor in order to determine the source of the fire and, depending on the detected source of the fire, to actuate the one spray nozzle having the manipulator(s) and/or the multiple valves of the spray nozzles.

Particularly preferably, a large number of sensors, in particular thermopile sensors, are arranged on the housing, which are oriented in different directions in order to detect a fire. Since a thermopile sensor alone is not suitable for determining the direction in which a fire is located, in this case a large number of sensors are used that point in different directions. In particular, the sensors are designed in such a way that they have a limited detection range that does not overlap or only slightly overlaps with the detection range of an adjacent sensor. As a result, as the number of sensors increases, a higher resolution of the surroundings of the fire extinguishing device is made possible in order to locate the fire particularly accurately. Through a suitable design of the control unit, either in the form of a circuit arrangement and/or with the aid of a microprocessor, the control device is actuated, depending on the output signals of the sensors, to apply the extinguishing agent in the desired direction. Or, as already mentioned above, each sensor is assigned a spray nozzle, which can be triggered directly by the assigned sensor.

The sensors are preferably arranged in a ring shape, in particular a circular ring shape, and in particular are each oriented radially outwards. The sensors also have the advantages already mentioned for the annularly arranged spray nozzles. In particular, both the sensors and the spray nozzles are arranged in a ring shape, in particular in a circular ring shape, wherein each spray nozzle is assigned one of the sensors. Preferably, the sensors and the respective assigned spray nozzles are oriented in the same direction, so that a simple selection of a spray nozzle to be triggered depending on a fire detected by one of the sensors is made possible.

Furthermore, it is preferably provided that the sensors and the spray nozzles are arranged on different circular lines or ring lines, wherein the sensors preferably lie radially outside the spray nozzles. In particular, a sensor and a spray nozzle lie on a common radial to the center of the ring shape, in particular the circular ring shape, and point in the same direction.

The extinguishing agent container is preferably made in a ring shape, in particular a circular ring shape, and is arranged coaxially to the side wall in the housing. Due to the ring shape of the extinguishing agent container, a receiving space is created, in particular in the center of the extinguishing agent container, in which other elements of the fire extinguishing device, such as in particular the control device, the valves and/or actuators, or the manipulators can be arranged. In addition, the ring shape offers the advantage that connection paths from the extinguishing agent container to multiple spray nozzles, which are also arranged in a ring, are of the same size.

Particularly preferably, the outer diameter of the extinguishing agent container corresponds at least substantially to the inner diameter of the side wall. The extinguishing agent container thus rests on or almost on the inside of the side wall of the housing. This means that the installation space within the housing is optimally utilized by the extinguishing agent container. Due to the particularly close arrangement to the side wall, an arrangement of the spray nozzles or sensors in this area is disadvantageous, which is why they are preferably arranged in the base of the housing. According to an alternative embodiment of the invention, the extinguishing agent container is arranged centrally with a circular contour, while the control device, valves, actuators, or manipulators lie in the space between the extinguishing agent container and the side wall.

Preferably, the height of the extinguishing agent container corresponds at least substantially to the height of the side wall, so that the height of the housing is also optimally utilized by the extinguishing agent container in order to be able to provide as much extinguishing agent as possible.

Furthermore, it is preferably provided that the extinguishing agent container is connected to all of the valves via a pipe or to each of the valves via a pipe. The valves are therefore either each connected directly to the extinguishing agent container or through a common distribution pipe or a distribution box that is connected to the extinguishing agent container. A common connection pipe or a distribution pipe offers the advantage that only one connection has to be provided on the extinguishing agent container itself, which means that a permanently secure seal of the extinguishing agent container against unwanted escape of extinguishing agent can be implemented cost-effectively.

According to a preferred embodiment of the invention, the extinguishing agent container is assigned a pre-loaded propellant for expelling the extinguishing agent. Due to the pre-loaded propellant, active pressure generation is not necessary in case of a fire. Rather, the pressurized propellant is available immediately or promptly to expel the extinguishing agent, so that little or no time passes after a fire has been detected by the fire extinguishing device.

The propellant preferably includes a displaceable piston having a pre-loaded spring element or a gas in the extinguishing agent container that is compressed to generate an overpressure in the extinguishing agent container. The displaceable piston is in particular a hydraulic piston which is drivable, for example, into the extinguishing agent container in order to displace volume. Due to the assignment of the pre-loaded spring element, the piston is spring-loaded. In particular, the piston is pre-loaded against a retractable locking element, which can be triggered or removed by the control device, so that the spring element can develop its effect and drive the piston into the extinguishing agent container to discharge the extinguishing agent. Alternatively or additionally, a compressed gas is present in the extinguishing agent container, so that the extinguishing agent container is already pre-loaded before assembly and before a fire is detected. By opening a valve connected to the extinguishing agent container, the gas can relax and thereby expel extinguishing agent through the valve and the assigned spray nozzle. Particularly preferably, at least one actuatable actuator for expelling the extinguishing agent from the extinguishing agent container is assigned to the extinguishing agent container. The actuator is in particular an electromotive, electromagnetic, or pyrotechnic actuator. In particular, the pyrotechnic actuator can generate a high pressure in a short time, which results in a rapid and, in particular, also wide expulsion of the extinguishing agent from the extinguishing agent tank or the activated spray nozzle.

Preferably, the control unit is also arranged in the housing, which is connected to the sensor(s) on the one hand and to the valves and/or the actuator and/or the manipulator on the other hand. The control unit, which is designed in particular as a circuit arrangement and/or having a microprocessor, as already mentioned above, makes it possible to fight the fire in a targeted manner using the one or more spray nozzles and the sensors.

An electrical energy storage device is preferably also arranged in the housing. This means that the fire extinguishing device is fully autonomous when electrical energy is required to actuate a manipulator or actuator and/or the propellant. Since the resulting extinguishing process is preferably short because a fire is fight directly and in a targeted manner by the design of the fire extinguishing device according to the invention, the electrical storage device does not have to hold a large amount of energy.

According to a further embodiment of the invention, an electrical connection device, in particular a connection cable, contact plug, or screw base, is arranged on the housing for electrically contacting the fire extinguishing device and/or for data transmission. As a result, the fire extinguishing device is connectable, for example, to an electrical supply to the building, so that an energy storage device or at least the replacement of the existing energy storage device can be omitted. By using a screw base, the fire extinguishing device can be screwed into a screw socket like a lamp and is therefore also fastenable on the ceiling of a room. In this case, the connection device is also used as a fastening means for the fire extinguishing device. According to a preferred refinement of the invention, at least one operable switch is arranged on the housing, wherein the control device is deactivatable for a predetermined time by operating the switch. A user can thus temporarily deactivate the fire extinguishing device by operating the switch, which is designed, for example, as a pushbutton switch, toggle switch, or pressure switch, in order to avoid unwanted triggering of the fire extinguishing device, for example if the fire extinguishing device is installed above a cooking area. Alternatively or additionally, the switch and the control device are designed such that one or more selected spray nozzles of the spray nozzles are permanently deactivatable by actuating the switch. As a result, for example, one of the spray nozzles, which points to a cooking area after the fire extinguishing device has been installed, can be permanently deactivated in order to avoid incorrect triggering. According to a further embodiment of the invention, the control device, in particular the control unit, is integratable into a smart home system, so that a user can select spray nozzles and/or sensors with the aid of a program interface that are to be deactivated for a certain period of time or permanently.

At least one electrical light source is preferably arranged on the housing. This means that the fire extinguishing device can also be used as a lamp or light. The light source can be selected in such a way that it is only used to mark the fire extinguishing device or in such a way that it is used to illuminate the room in which it is arranged or in which it can operate. This is particularly advantageous if the fire extinguishing device has an electrical connection for a power supply to the building. Otherwise, the light source is powered by energy from the electrical energy storage device. Optionally, a motion detector is also arranged on the housing, which activates the light source when movement is detected.

The fire extinguishing device particularly preferably includes a holding rail and/or at least one fastening tab for mounting on a wall or ceiling. The holding rail is in particular detachably held on the housing, in particular on the side wall, in order to be able to be pre-installed on the wall or ceiling. For this purpose, the holding rail includes, for example, one or more openings for fastening screws. Preferably, the holding rail has holding tabs at the end which, when installed as intended, point in the direction of the base of the housing, i.e., into the housing, and in particular can be screwed to the side wall. This means that the housing is subsequently installable on the holding rail and is also easily removable therefrom if necessary. Alternatively or additionally, the side wall includes the at least one laterally projecting fastening tab on its end face facing away from the base as a fastening means. For example, a fastening screw can be guided through the fastening tab, by means of which the housing or the fire extinguishing device is securely fastenable to the wall or ceiling.

Optionally, the fire extinguishing device also includes at least one optical and/or acoustic signal generator, which is designed to also output an acoustic and/or optical signal when an extinguishing process is triggered, in particular in the manner of a smoke detector. The signal generator preferably includes a sound generator or loudspeaker. Alternatively or additionally, the signal generator includes a light source, in particular an LED, for example the light source already mentioned. Preferably, the fire extinguishing device also includes a smoke sensor in order to issue an alarm by means of the signal generator when smoke is detected. In this respect, a smoke detector is preferably integrated into the fire extinguishing device.

### BRIEF DESCRIPTION OF THE DRAWINGS

The invention will be explained in more detail below with reference to the drawing. In the figures

FIG. 1 shows an advantageous fire extinguishing device in a perspective view according to a first exemplary embodiment,

FIG. 2 shows the fire extinguishing device from FIG. 1 in a perspective top view,

FIG. 3 shows the fire extinguishing device from FIG. 1 in a simplified cross-sectional view,

FIG. 4 shows the fire extinguishing device in a perspective view according to a second exemplary embodiment,

FIG. 5 shows a simplified cross-sectional view of the fire extinguishing device according to the second exemplary embodiment, and

FIG. 6 shows a perspective top view of the fire extinguishing device according to the second exemplary embodiment.

### DESCRIPTION OF EXAMPLE EMBODIMENTS

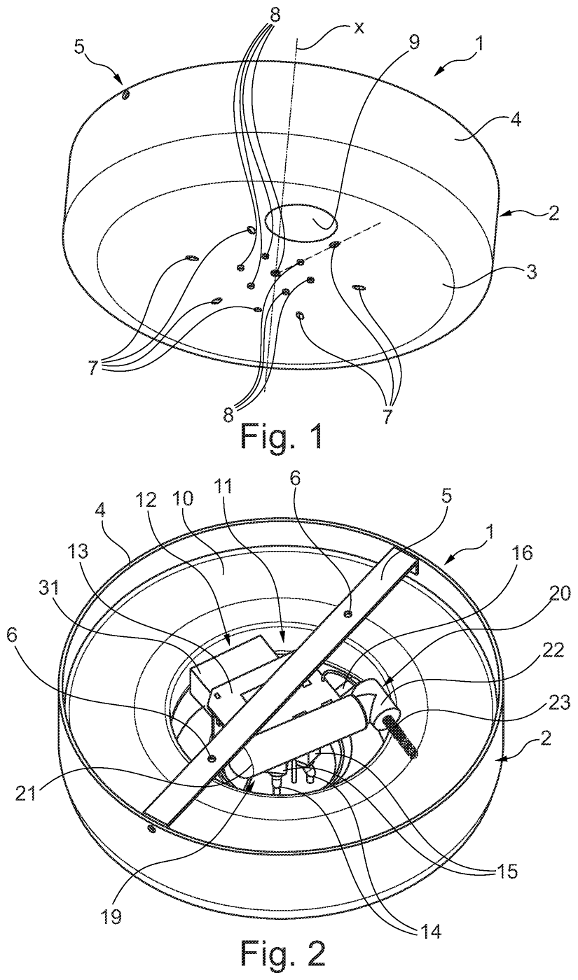

FIG. 1 shows a perspective view of an advantageous fire extinguishing device 1, which includes a trough-shaped or cup-shaped housing 2, having a circular base 3 and a side wall 4, which projects particularly vertically from the circular base and extends over the entire circumference of the base 3 and thus forms a closed side wall or jacket wall of the housing 2. The housing 2 includes fastening means on its end face facing away from the base 3. According to the present exemplary embodiment, as also shown in detail in FIG. 2, a holding rail 5 or strut is provided as a fastening means, which extends diagonally through the housing 2 and includes one or more, in the present case two openings 6 for guiding through a fastening screw in each case, so that by means of the fastening screws the housing 2 and thus the fire extinguishing device 1 can be attached in a simple manner, for example to the ceiling or wall of a room.

As shown in FIG. 2, the holding rail has a folded or bent holding tab at each end, which is used to oppose, in particular, press against the inside of the side wall 4. The respective holding tab preferably includes a further opening, which, when installed as intended, is opposite an opening in the side wall 4, so that a fastening screw can be guided through the opposite openings in the holding tab and the side wall and, for example, tightened using a nut to fasten the housing 2 permanently to the holding rail, which is expediently first installed on the wall or ceiling. According to an alternative exemplary embodiment, this side wall 4 has, as fastening means, multiple retaining tabs projecting radially outwards, which are assigned to the end face, are preferably formed in one piece with the side wall 4, and each include at least one opening for the passage of a screw shaft of a fastening screw.

While according to the present exemplary embodiment the side wall 4 is designed to be closed overall, the base 3 has a plurality of openings 7 and 8, the function of which will be discussed in more detail below. The openings 7 lie on a first circumference relative to a central longitudinal axis x of the housing 2, and the openings 8 on a second circumference, which is smaller than the first circumference. The openings 7 and 8 are each arranged evenly distributed along the circumferential lines. Because the openings 7 lie on a first circumference and the openings 8 on a second circumference, the openings are arranged in a ring shape and in this case in a circular ring shape. The number of openings 7 corresponds to the number of openings 8. Starting from the central longitudinal axis x, one opening 7 and one opening 8 lie on a radial to the central longitudinal axis x, i.e., on an imaginary straight line that starts from the central longitudinal axis, as shown by a dashed line in FIG. 1.

Preferably, as shown in FIG. 1, a further opening 8 and/or a further opening 7 is formed centrally or at least substantially centrally in the base 3, with respect to the annular arrangement of the remaining openings 8, in the base 3.

Furthermore, a user-operable switch 9, which is designed as a push-button switch or touch-sensitive switch 9, is optionally arranged on the base 3 spaced apart from the circumferences on which the openings 7 and 8 lie. The function of the switch 9 will be discussed in more detail later.

FIG. 2 shows a perspective top view of the fire extinguishing device 1 on the end face facing away from the base 3. Due to the trough shape of the housing 2, the end face is open. Optionally, the end face is closed by a lid, not shown here.

An extinguishing agent container 10 is arranged in the housing 2. According to the present exemplary embodiment, the extinguishing agent container 10 is designed in the shape of a circular ring and has an outer diameter which essentially corresponds to the inner diameter of the side wall 2, so that the extinguishing agent container 10 preferably rests on the inside of the side wall 2. The height of the extinguishing agent container 10 preferably corresponds to the height of the side wall 2 or almost the height of the side wall 2. Due to the ring shape of the extinguishing agent container 10, it forms a receiving space 11 in the middle. By choosing the inner diameter of the extinguishing agent container 10, the receiving space 11 is preferably designed in such a way that there is space in this means for discharging the extinguishing agent stored in the extinguishing agent container 10.

In the present case, a control device 12 is arranged in the receiving space 11, which is designed to discharge the extinguishing agent in a targeted manner to fight a fire. For this purpose, the control device 12 preferably includes a control unit 13 that is designed in the form of a circuit arrangement, in particular in the form of an integrated circuit and/or having a microprocessor.

Furthermore, a large number of spray nozzles 14 are arranged in the receiving space, each of which opens into one of the openings 8. Otherwise, the spray nozzles 14 are located within the receiving space 11 or the housing 2, so that they do not appear from the outside. Each spray nozzle 14 is assigned an actuatable valve 15, which is operable by the control unit 13. The valves 15 are connected between the assigned spray nozzles 14 and the extinguishing agent tank 10. For this purpose, the valves 15 are connected to a distribution pipe 16, which leads into the extinguishing agent tank. The distribution pipe 16 opens into the extinguishing agent tank 10 near the base 3 and thus, when intended, at the base of the extinguishing agent tank 10. The distribution pipe 16 preferably leads to the lowest point of the extinguishing agent tank 10 in order to utilize the full volume of the extinguishing agent tank 10 when discharging extinguishing agent.

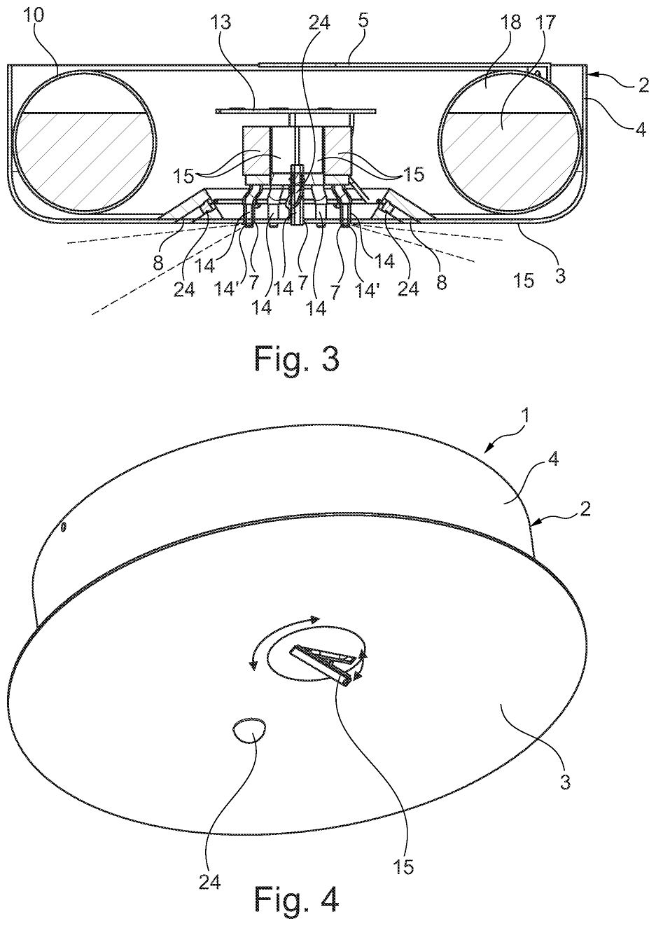

FIG. 3 shows for this purpose, in a simplified cross-sectional view of the fire extinguishing device 1, that the extinguishing agent tank 10 preferably has a circular cross section and is not completely filled with extinguishing agent 17. This leaves a gas volume 18 in the extinguishing agent tank 10, which lies above the extinguishing agent 17 when installed as intended, as shown in FIG. 3.

As shown in particular in FIGS. 2 and 3, the extinguishing agent tank 10 is also assigned an advantageous propellant 19, which is used to expel the extinguishing agent 17 under pressure from the extinguishing agent tank 10 through at least one of the spray nozzles 14. According to the following exemplary embodiment, the propellant 19 includes a pyrotechnic actuator 20, which in the present case includes a pressure cartridge 21 and a pyrotechnic valve 22, wherein the valve 22 is triggerable by the control unit 13 and connects the pressure cartridge 21 to the extinguishing agent tank 10. For this purpose, a pipe 23 leads from the valve 22 into the extinguishing agent container 10, specifically in a region of the extinguishing agent container 10 facing away from the base 3 or at the top, so that the pipe 23 leads into the gas volume 18.

If the valve 22 is triggered by the control unit 13, the pressure from the pressure chamber 21 is released and acts on the extinguishing agent 17 located in the extinguishing agent container 10, so that it is expelled from the associated spray nozzle 14 if at least one of the valves 15 is open. Optionally, the pressure chamber 21 is designed as a pyrotechnic pressure chamber, which can be triggered by the control unit 13 in order to suddenly generate a high pressure by way of a pyrotechnic reaction, which acts on the extinguishing agent in the extinguishing agent container 10.

As can be seen in FIG. 3, each of the openings 7 is assigned a sensor 24 which is suitable for detecting a fire. The sensors 24 are preferably designed as thermopile sensors, also called thermopiles. They convert thermal energy into electrical energy and can therefore generate an electrical signal, which can be evaluated by the control unit 13, when a fire is detected, without having to work with an operating voltage themselves. Alternatively, the signal is used directly to operate the valve 15 of a spray nozzle 14 assigned to the sensor 24. At least the sensors 24, the control unit 13, the valves 15, and optionally also the actuator 20 are to be understood in the present case as part of the control device 12, which operates the fire extinguishing device 1.

The central opening 8 is also assigned a spray nozzle 14, by means of which extinguishing agent can be discharged from the housing 2 perpendicular to the base 3, so that, for example, an area directly below the fire extinguishing device, when the fire extinguishing device is mounted on the ceiling, can also be subjected to extinguishing agent. Optionally, a further sensor 24 is also integrated into this central opening 8 or a further opening 7 is formed next to this opening 8, to which the further sensor 24 is assigned.

The annularly arranged spray nozzles 14 are each oriented inclined and designed in such a way that they essentially point radially outwards and are oriented inclined to the base 3, in particular at an angle of 5° to 40°, in particular 15°. For this purpose, the spray nozzles according to the present exemplary embodiment each have a lateral opening 14′ at their free end, which points radially outwards and produces a spray cone which is oriented at the specified angle to the base 3. The openings 14′ are expediently located below the base 3 or outside the housing 2.

The mode of operation of the fire extinguishing device 1 is as follows: First, the user can arrange the fire extinguishing device 1 at any location, for example and preferably on the ceiling of a room, and fasten it thereon with the aid of the fastening tabs 5. The extinguishing agent container 10 is already prefilled, as shown in FIG. 3, with extinguishing agent 17 and a gas volume 18.

In addition, an electrical energy storage device 31 is arranged in the receiving space 11, which in particular provides the energy necessary for operating the valves 15, 22 and, if necessary, also energy for operating the sensors 24. Alternatively or additionally, the control unit 13 has an electrical connection device, such as a contact plug or screw base, in order to be able to connect the fire extinguishing device 1 electrically to a power supply of the building in which the fire extinguishing device 1 is installed.

If the fire extinguishing device 1 is installed, the sensors 24 are active and detect the surroundings of the fire extinguishing device 1. As already explained above, the sensors 24 or the openings 8 are arranged evenly distributed over the circumference of the base 3 and each point radially outwards, so that they detect different sections of the space. Each sensor detects a circular segment-shaped area of the space, viewed in a top view. In fact, the sensors 24 preferably each detect conical areas in the space. If one of the sensors 24 detects a fire, it outputs a corresponding output signal, which is evaluated by the control unit 13 or is used directly to actuate the valve 15 of the spray nozzle 14 lying on the same radial, so that the spray nozzle 14 pointing in the same direction as the sensor 24, which detected the fire, is subjected to the extinguishing agent 17 from the extinguishing agent tank 10. When the fire is detected by the sensor 24, the control unit 13 also triggers the valve 22 or the pyrotechnic driver/actuator in order to increase the pressure in the extinguishing agent tank 10. The gas volume 18 is thus pre-loaded in the extinguishing agent tank and drives the extinguishing agent 17 out of the extinguishing agent tank 10 in the direction of the opened valve 15 and the assigned spray nozzle 14.

The fire extinguishing device 1 thus works automatically and fights a fire in a targeted manner by only dispensing the extinguishing agent in the direction in which a fire was detected. Particularly when using the electrical energy storage device 31 without an additional connection device, the fire extinguishing device 1 is designed to be autonomous.

The switch 9 is preferably connected to the control unit 13 in order to deactivate the function of the fire extinguishing device 1 for a predetermined period of time when it is operated. By operating the switch 9, the user can ensure that the fire extinguishing device 1 does not react to fires or suspected fires for a predetermined period of time. This is advantageous, for example, if the fire extinguishing device 1 is installed above a cooking area.

Due to the autonomous design of the fire extinguishing device 1, the user can arrange it anywhere where there is space for the fire extinguishing device 1. It is not dependent on electrical and/or hydraulic connections of supply systems of the building in which the fire extinguishing device 1 is to be installed. As a result, the fire extinguishing device 1 offers a high degree of flexibility, wherein it can be installed by anyone, since no special prior knowledge is required for installation.

FIGS. 4 to 6 show a second exemplary embodiment of the fire extinguishing device 1, wherein elements already known from the previous exemplary embodiment are provided with the same reference numerals and reference is made to the description above. In the following, essentially only the differences will be discussed.

FIG. 4 shows a perspective view of the fire extinguishing device 1 with a view of the base 3. As a significant difference of the second exemplary embodiment, the fire extinguishing device 1 only includes one spray nozzle 14. While in the previous exemplary embodiment the spray nozzles 14 are fixedly arranged and oriented on the housing 2, according to the second exemplary embodiment it is provided that the one spray nozzle 14 is displaceably held on the housing 2, in particular on the base 3. The spray nozzle 14 in the present case is mounted here so that it is rotatable or pivotable around a vertical axis or around the central longitudinal axis x, as well as around a horizontal axis perpendicular to the central longitudinal axis x. As a result, the spray nozzle 14 can be pivoted in any direction in order to discharge the extinguishing agent 17 from the extinguishing agent tank 10 in a selected direction.

In addition, the fire extinguishing device 1 according to the second exemplary embodiment includes a single sensor 24 for detecting a fire instead of multiple sensors 24. In this case, the sensor 24 is designed as a camera sensor, in particular as an infrared camera sensor, which detects the surroundings of the fire extinguishing device 1. For this purpose, the camera sensor has a particularly large detection range, which is made possible, for example, with the aid of a so-called fisheye lens. It is determined by image evaluation by means of the control unit 13 whether and where there is a fire.

Depending on this detection, the control unit 13 then actuates a first actuatable manipulator 25, by means of which the spray nozzle 14 is pivotable around the horizontal axis, and a second actuatable manipulator 26, by means of which the spray nozzle 14 is rotatable around the vertical axis, to orient the spray nozzle 14 optimally in the direction of the fire. In particular, the spray nozzle 14 is pivotable by the first manipulator 25 by at least 90° between a starting position that is in particular flush with the base 3 and oriented in the plane of the base 3 and a maximum position projecting vertically from the base 3, and by the second manipulator 26 by at least 360°. After orientation has been completed, the control unit 13 also actuates the propellant 19 to discharge the extinguishing agent 17 from the extinguishing agent tank 10.

The propellant can be the same propellant as in the first exemplary embodiment. Alternatively, as shown by way of example in FIG. 6, the propellant 19 in this case is an electrically actuatable feed pump 27 which is arranged in the receiving space 11. The feed pump 27 is connected on the suction side to the extinguishing agent container 10 and on the pressure side to the one spray nozzle 14 in order to expel the extinguishing agent from the extinguishing agent tank 10 through the spray nozzle 14.

Furthermore, the second exemplary embodiment differs from the first exemplary embodiment in that the base 3 optionally extends radially beyond the side wall 4. An annular projection 28 is thus created on the back of the base 3 facing toward the side wall 4. A strip-shaped, in particular annular, light source 29, for example in the form of an LED strip, is preferably arranged thereon, which is actuatable and operable in particular by the control unit 13. For example, the control unit 13 actuates the light source 29 as a signal generator, for example, to mark the triggered fire extinguishing device 1 in the event of a fire or to visually report an extinguishing event and/or to illuminate the space in the surroundings of the fire extinguishing device 1. Alternatively, the light source 29 can also be used as lighting for the space in which the fire extinguishing device 1 is arranged, independently of whether a fire is detected. Optionally, an acoustic signal generator in the form of a sound generator or loudspeaker can also be used as a signal generator.

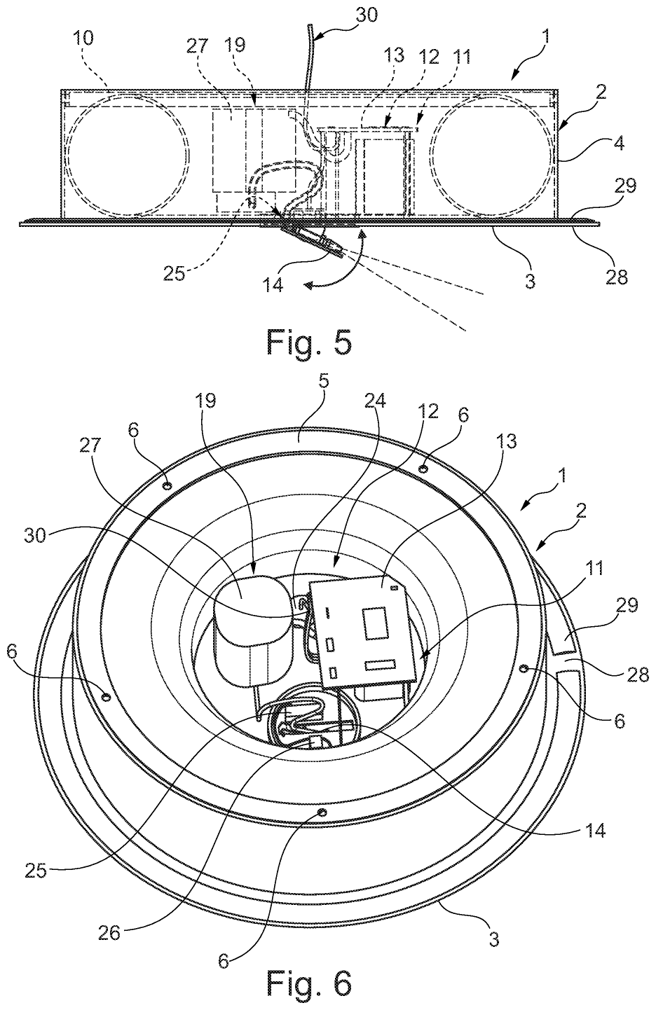

According to the exemplary embodiment shown in FIGS. 4 to 6, the fire extinguishing device 1 also includes the previously mentioned connection device 30, which is designed as an electrical connection device in order to be connected to a power supply of the building. In the present case, the connection device 30 preferably includes one or more connection cables, as shown by way of example in FIGS. 5 and 6, which preferably terminate in a connection plug or in a screw base. In addition, the energy storage device 31 is provided, which ensures the energy supply to the fire extinguishing device 1. In the exemplary embodiment of FIGS. 4 to 6, the energy storage device 31 is used in particular as an auxiliary energy storage device or as an electrical buffer storage device, which maintains the energy supply through the connection device 30 in the event of brief power outages.

In both cases, the fire extinguishing device 1 is at least designed as an extinguishing agent-autonomous extinguishing device 1, which easily replaces a room-related sprinkler system. Due to the direction-dependent discharge of the extinguishing agent 17, a fire is fought accurately and therefore particularly effectively. In addition, a minimal use of extinguishing agent is ensured here, which means that minimal damage can be caused by the extinguishing agent in the room.

The extinguishing agent container 10 preferably has a capacity for 0.5 to 5 liters of extinguishing agent and optionally for the gas volume 18. Non-toxic extinguishing agents, such as water or soapy water, are preferably stored or kept in the extinguishing agent container 10. The extinguishing agent is conveyed by the feed pump 27 or by the propellant 19 described at a pressure of preferably 0.5 to 50 bar, preferably 1 to 10 bar.

The gas volume 18 in the extinguishing agent tank 10 itself is also used as a propellant. Even without the pyrotechnic actuator 19, the extinguishing agent 17 can advantageously be discharged from the selected or the one spray nozzle 14, in that the gas volume 18 in the extinguishing agent container 10 is compressed and thus exerts a pre-stress in the extinguishing agent container 10 on the extinguishing agent 17. As soon as one of the valves 15 is opened, the pre-loaded propellant or gas volume 18 then displaces the extinguishing agent 17 to the corresponding spray nozzle 14. This makes it possible to dispense with a pyrotechnic actuator and/or a pump device.

Optionally, the switch 9 having the control unit 13 is set up to permanently deactivate individual areas or sensors 24, for example to ensure that certain areas in the space are not taken into consideration by the fire extinguishing device 1. In this way, individual directions or directions of action of the fire extinguishing device 1 can be deactivated by the user.

In the present case there are six sensors 24 and spray nozzles 15, which are arranged evenly distributed over the circumference. However, the number of sensors and/or spray nozzles 15 is variable and can also be increased or reduced.

Alternatively to deactivating individual areas or sensors 24 by means of the switch 9, covers are provided by means of which individual openings 8 can be closed in order to permanently deactivate the respective area.

According to a further exemplary embodiment, areas are preferably deactivated based on software by deactivating areas of the camera image or not taking them into consideration when evaluating and detecting a fire.

The connection device 30 is preferably also designed for data transmission, in particular for connection to a smart home system, in particular a KNX system, so that programming or selection of active and inactive areas of the fire extinguishing device 1 can be carried out by the user in a simple manner.

While according to the present exemplary embodiment of FIGS. 4 to 6 the spray nozzle 14 can be pivoted in multiple directions (3D pivoting), according to a further exemplary embodiment it is provided that the spray nozzle 14 can only be pivoted in one direction (2D) or has only one degree of freedom. According to a further exemplary embodiment, the spray nozzle 14 is only pivotable around the vertical axis in order to be oriented in a selected spatial direction.

FIG. 6 also shows a further exemplary embodiment of the fastening means. In this exemplary embodiment, the holding rail 5 is designed in the shape of a circular ring, having an outer diameter that at least substantially corresponds to the inner diameter of the side wall 4. The holding rail 5 includes multiple openings 6, which are arranged in particular evenly distributed over the circumference. In addition, the holding rail 5 in this case preferably includes multiple lateral, radially outer fastening tabs which lie parallel to the side wall and each include an opening which is opposite to an opening in the side wall in order to enable screwing to the housing. Alternatively, in the exemplary embodiments mentioned, the holding rail 5 includes latching elements on the fastening tabs, which cooperate with counter-latching elements of the housing 2, so that tool-free fastening of the housing 2 to the holding rail 5 pre-installed on the building is possible.

1. A fire extinguishing device for automatically fighting fires, having a housing, which includes at least one fastening means for fastening the device on a wall or ceiling, of a building, having an extinguishing agent container, arranged in the housing, having a fluid extinguishing agent, having at least one spray nozzle for discharging the extinguishing agent from the extinguishing agent container, having at least one sensor designed to detect a fire and its position in the surroundings of the device, and having at least one control device designed to discharge the extinguishing agent from the extinguishing agent container through the at least one spray nozzle in the direction of the detected fire.

2. The fire extinguishing device according to claim 1, wherein a plurality of spray nozzles which are oriented in different directions are arranged on the housing.

3. The fire extinguishing device according to claim 1, wherein each spray nozzle is assigned an activatable valve of the control device, by which the respective spray nozzle is connectable to the extinguishing agent container and disconnectable therefrom.

4. The fire extinguishing device according to claim 1, wherein the housing is trough-shaped and has a base and a side wall which protrudes from the base and leads around the circumference of the base, wherein the sensors and the spray nozzles are arranged in the base.

5. The fire extinguishing device according to claim 1, wherein the spray nozzles are arranged in a ring shape, in particular in a circular ring shape, and in particular are each radially oriented inclined to the base.

6. The fire extinguishing device according to claim 5, wherein at least one further spray nozzle is arranged centrally and oriented perpendicular to the base.

7. The fire extinguishing device according to claim 1, wherein the at least one spray nozzle is held displaceably on the housing (2) in order to be able to be oriented in different directions.

8. The fire extinguishing device according to claim 1, wherein the at least one spray nozzle is assigned at least one electrically actuatable manipulator, which is designed to orient the spray nozzle (14) in the direction in which a fire was detected.

9. The fire extinguishing device according to claim 1, wherein the sensor is designed as a thermopile sensor, infrared sensor, and/or camera sensor.

10. The fire extinguishing device according to claim 1, wherein a plurality of sensors, in particular thermopile sensors, are arranged on the housing, which are oriented in different directions in order to detect a fire.

11. The fire extinguishing device according to claim 1, wherein the sensors are arranged in a ring shape, in particular in a circular ring shape, and in particular are each oriented pointing radially outward.

12. The fire extinguishing device according to claim 1, wherein the sensors on the one hand and the spray nozzles on the other hand are arranged on different circumferences or circular lines.

13. The fire extinguishing device according to claim 1, wherein the extinguishing agent container is in a ring shape, in particular in a circular ring shape, and is arranged coaxially to the side wall in the housing.

14. The fire extinguishing device according to claim 1, wherein an outer diameter of the extinguishing agent container corresponds at least substantially to the inner diameter of the side wall.

15. The fire extinguishing device according to claim 1, wherein a height of the extinguishing agent container corresponds at least substantially to the height of the side wall.

16. The fire extinguishing device according to claim 1, wherein the extinguishing agent container is connected to all of the valves by a distribution pipe or to each of the valves by a pipe in each case.

17. The fire extinguishing device according to claim 1, wherein the extinguishing agent container is assigned a pre-loaded propellant in particular for expelling the extinguishing agent.

18. The fire extinguishing device according to claim 1, wherein the propellant includes a displaceable piston having a pre-loaded spring element or a compressed or compressible gas volume in the extinguishing agent container to generate an overpressure in the extinguishing agent container.

19. The fire extinguishing device according to claim 1, wherein the extinguishing agent container is assigned at least one actuatable actuator for expelling the extinguishing agent from the extinguishing agent container.

20. The fire extinguishing device according to claim 1, wherein the actuator is an electromotive, electromagnetic, or pyrotechnic actuator.

21. The fire extinguishing device according to claim 1, wherein a control device is arranged in the housing and is connected to the sensor or sensors on the one hand and to the valves and/or the actuator on the other hand.

22. The fire extinguishing device according to claim 1, wherein an electrical energy storage device is arranged in the housing.

23. The fire extinguishing device according to claim 1, wherein an electrical connection device, in particular connecting cable, contact plug, or screw base, for electrically contacting the fire extinguishing device and/or for data transmission, in particular of the control device, is arranged on the housing.

24. The fire extinguishing device according to claim 1, wherein at least one operable switch is arranged on the housing, wherein the control device is deactivatable for a predetermined period of time by operating the switch, or wherein one or more selected spray nozzles of the spray nozzles are permanently deactivatable by operating the switch.

25. The fire extinguishing device according to claim 1, wherein at least one electric light source is arranged on the housing.

26. The fire extinguishing device according to claim 1, wherein it includes a holding rail and/or at least one fastening tab for installation on a wall or ceiling.
